(19) United States
(12) Patent Application Publication
(10) Pub. No.: US 2019/0078864 A1
(43) Pub. Date: Mar. 14, 2019

(54) SQUARE TOOL

(71) Applicant: Jonathan Colin CAVENAGH, Tasmania (AU)

(72) Inventor: Jonathan Colin CAVENAGH, Tasmania (AU)

(21) Appl. No.: 15/702,498

(22) Filed: Sep. 12, 2017

(51) Int. Cl. G01B 3/56; B25H 7/02; G01B 5/245

(52) U.S. Cl. CPC G01B 3/566; G01B 5/245; B25H 7/02

(57) ABSTRACT

A square tool includes a first arm and a second arm which are disposed at 90° (right angle) to each other. Specifically, the arms each have an outer work edge which are set at right angles to each other. In contrast to a typical square tool where the arms meet at a corner junction, in the square tool of the present invention, the arms have inner ends which are spaced from each other and are joined by a connector therebetween. The connector provides a space where the projected corner junction of the arms would be located.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to square tool.

### 2. Description of Related Art Including Information Disclosed Under 37 CFR 1.97 and 37 CFR 1.98

Square tools are used by carpenters or woodworkers to lay out a “square” or right-angle between two components. Square tools are known by many names including try square (or tri square), rafter square, framing square, steel square or combination square.

The present invention seeks to overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### BRIEF SUMMARY OF THE INVENTION

According to a first aspect, the present invention provides a square tool comprising a first arm and a second arm having work edges disposed at 90° to each other, wherein the arms comprise inner ends which are spaced from each other and are joined by a connector therebetween, the connector being adapted to provide a space where the projected corner junction of the first and second arms would be located

In one embodiment, the arms each have an outer edge which are set at right angles to each other.

In another embodiment, the connector extends directly between the inner ends, the connector being at an obtuse angle relative to the arms.

In another embodiment, the arms comprise a T-shaped cross-section, L-shaped cross-section or flat cross-section.

In another embodiment, the connector is a right angled connector directed away from the space.

In another embodiment, the connector extends from inner edges of the arms.

In another embodiment, the connector comprises first and second sections at a right angle to each other, where an end of each section is connected to a respective inner end of the arms.

In another embodiment, the connector is a curved connector in the shape of an arc.

In another embodiment, the connector extends from the outer edges of the arms.

In another embodiment, the connector is shaped as a three-quarter section of a ring.

In another aspect, the present invention provides a tool comprising a first arm and a second arm having work edges disposed at an angle to each other, wherein the arms comprise inner ends which are spaced from each other and are joined by a connector therebetween, the connector being adapted to provide a space where the projected corner junction of the first and second arms would be located.

In one embodiment, the angle is a set angle of 45°, 60° or 30°.

In another embodiment, the angle is adjustable, the connector being adapted to vary and set the angle between the work edges

Other aspects of the invention are also disclosed.

### BRIEF DESCRIPTION OF THE SEVERAL VIEWS OF THE DRAWINGS

Notwithstanding any other forms which may fall within the scope of the present invention, preferred embodiments of the present invention will now be described, by way of examples only, with reference to the accompanying drawings.

FIG. 1 is a side view of a square tool in accordance with a first preferred embodiment of the present invention.

FIG. 1b is a perspective view of the square tool in another embodiment.

FIG. 2 is a side elevation view of the square tool of FIG. 1 in an example use.

FIG. 3 is a cross-sectional view of one arm of the square tool of FIG. 1b.

FIGS. 4 to 12 show schematic views of alternative embodiments of the square tool of the present invention.

### DETAILED DESCRIPTION OF THE INVENTION

It should be noted in the following description that like or the same reference numerals in different embodiments denote the same or similar features.

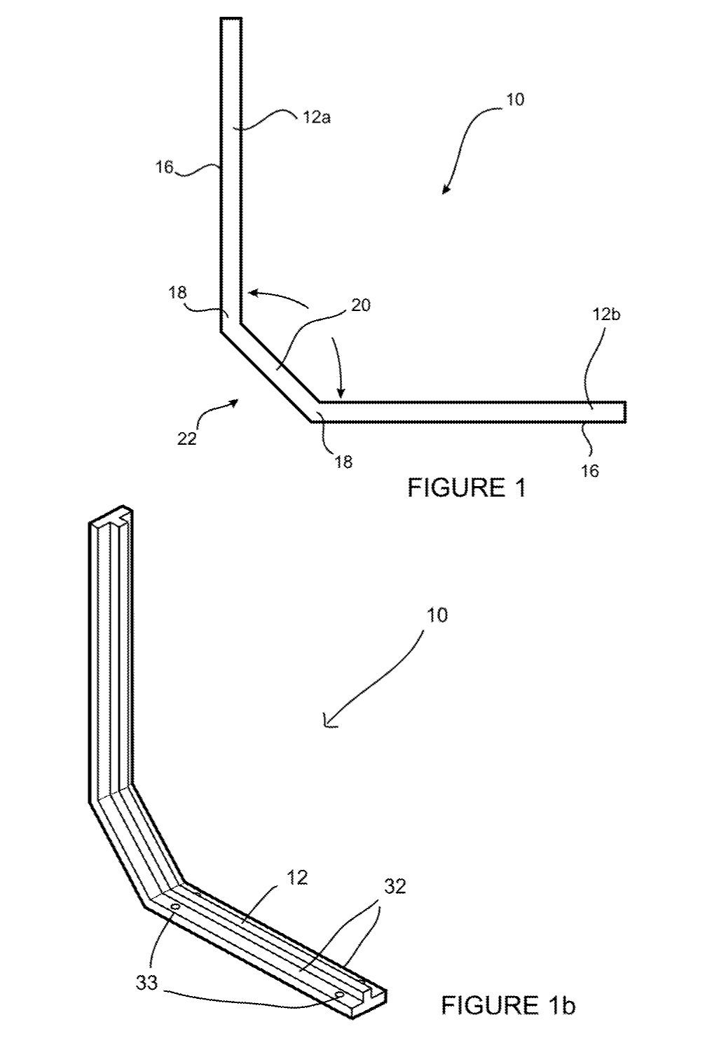

FIG. 1 shows a square tool 10 according to a preferred embodiment of the present invention. The square tool 10 comprises a first arm 12a and a second arm 12b which are disposed at 90° (right angle) to each other. Specifically, the arms 12 each have an outer work edge 16 which are set at right angles to each other.

In contrast to a typical square tool where the arms meet at a corner junction, in the square tool 10 of the present invention the arms 12 comprise inner ends 18 which are spaced from each other and are joined by a connector 20 therebetween. The connector 20 in the embodiment of FIG. 1 extends directly between the inner ends 18, thus the connector 20 is at an (internal) acute angle relative to the arms 12. The connector 20 thus provides a space 22 where the projected corner junction of the arms 12a and 12b would be located.

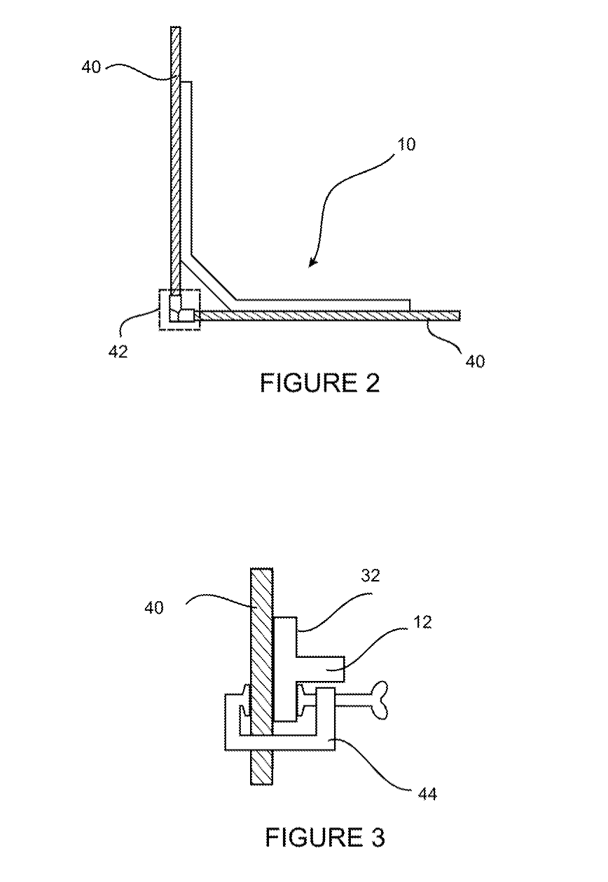

As shown in FIG. 2, the square tool 10 can be used to check the right) (90°) angle between inner surfaces of adjacent perpendicular components 40, even if there is an obstruction 42 at the corner junction between the components 40. The components 40 for example can be walls and the obstruction 42 can be a formation or structure at the wall corner.

As shown in FIGS. 3 and 1b, the arms 12 can have an upside down T-shaped cross-section (or an L-shaped cross-section or flat cross-section) which will provide surfaces 32 for engagement of clamps 44. The clamp 44 can be used for example to retain the square tool 10 to the component 40.

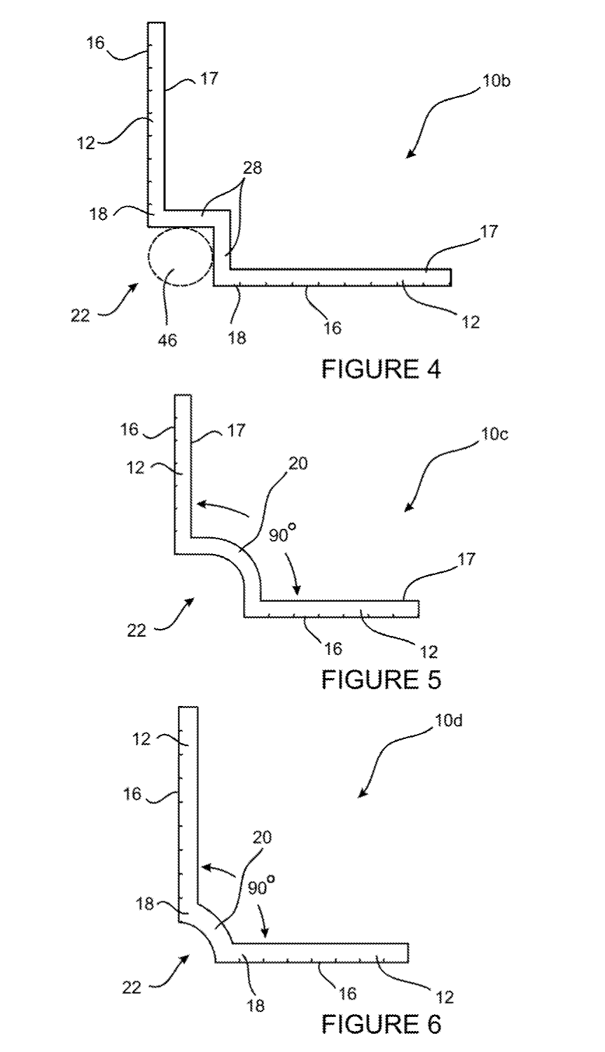

FIG. 4 shows an alternative embodiment of the square tool 10b, where the connector 20 is a right angled connector directed away from the space 22. The connector 20 extends from inner edges 17 of the arms 12. The connector 20 comprises first and second sections 28 at right angle to each other, where an end of each section 28 is connected to a respective inner end 18 of the arms 12. This embodiment for example can be used where a corner obstruction such as a pipe 46 exists.

FIG. 5 shows another alternative embodiment of the square tool 10c, where the connector 20 is a curved connector in the shape of an arc generally being a quarter of a circle. The arc connector 20 also extends from inner edges 17 of the arms 12.

FIG. 6 shows another alternative embodiment of the square tool 10d, where the connector 20 is also shaped as an arc, but of smaller dimensions. The inner ends 18 of the arms 12 are thus closer in this embodiment.

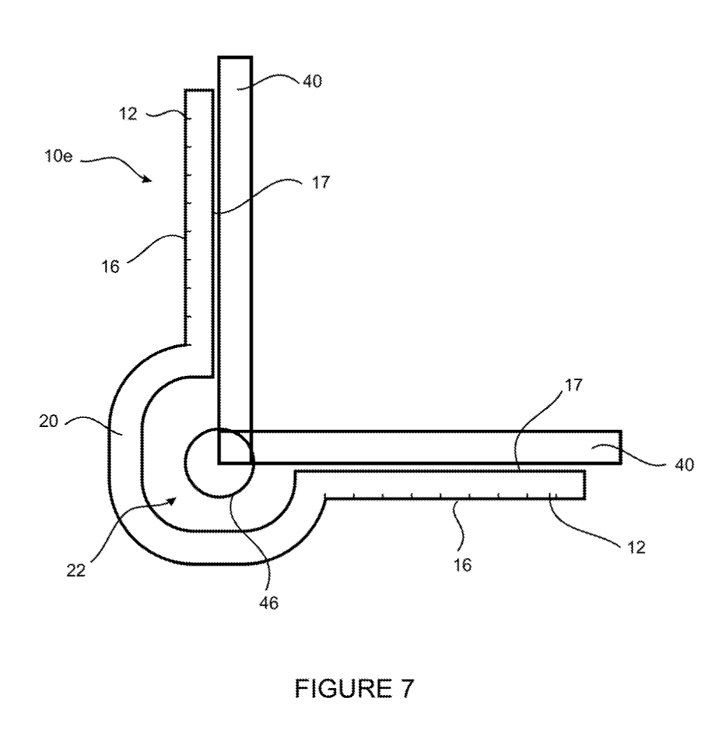

FIG. 7 shows another alternative embodiment of the square tool 10e, where the connector 20 extends from the outer edges 16 of the arms 12. The connector 20 in this embodiment is shaped as a three-quarter section of a ring. The square tool 10e can be used to test the square of external surfaces of the walls 40, where inner edges 17 of the arms 12 are the work edges for measurement. The connector 20 provides the space 22 which can receive a corner obstruction such as a pipe or formation 46.

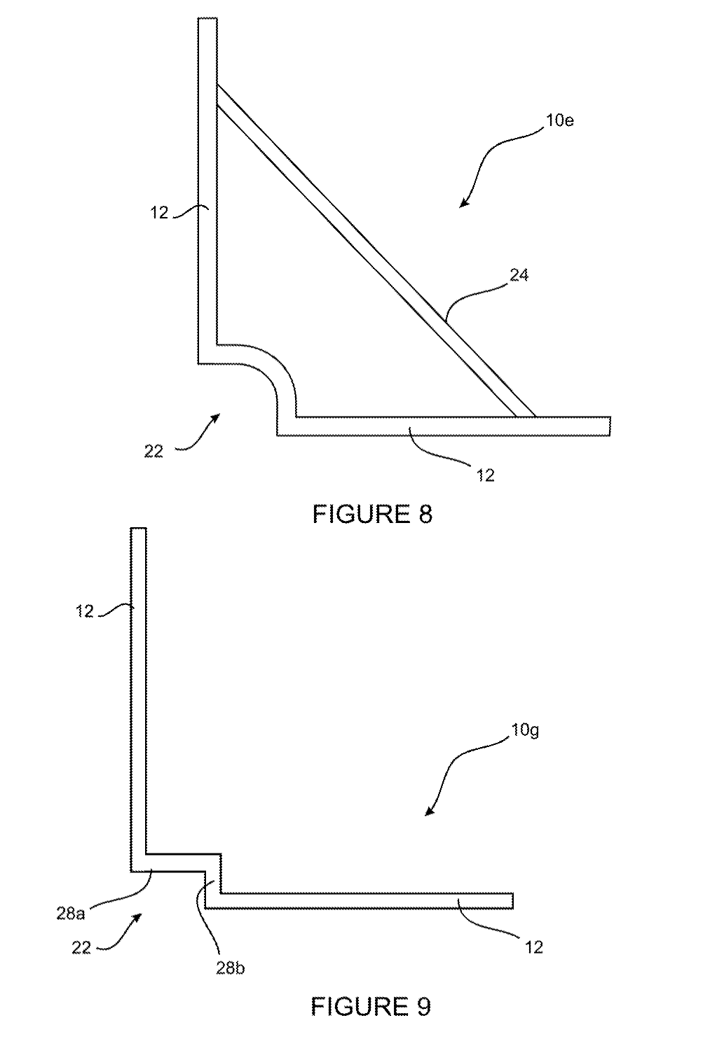

FIG. 8 shows another alternative embodiment of the square tool 10f which is similar to the embodiment 10c but further including a straight reinforcement member 24 between the arms 12.

FIG. 9 shows another alternative embodiment of the square tool 10g which is similar to the embodiment 10b but where first section 28a is longer than the second section 28b

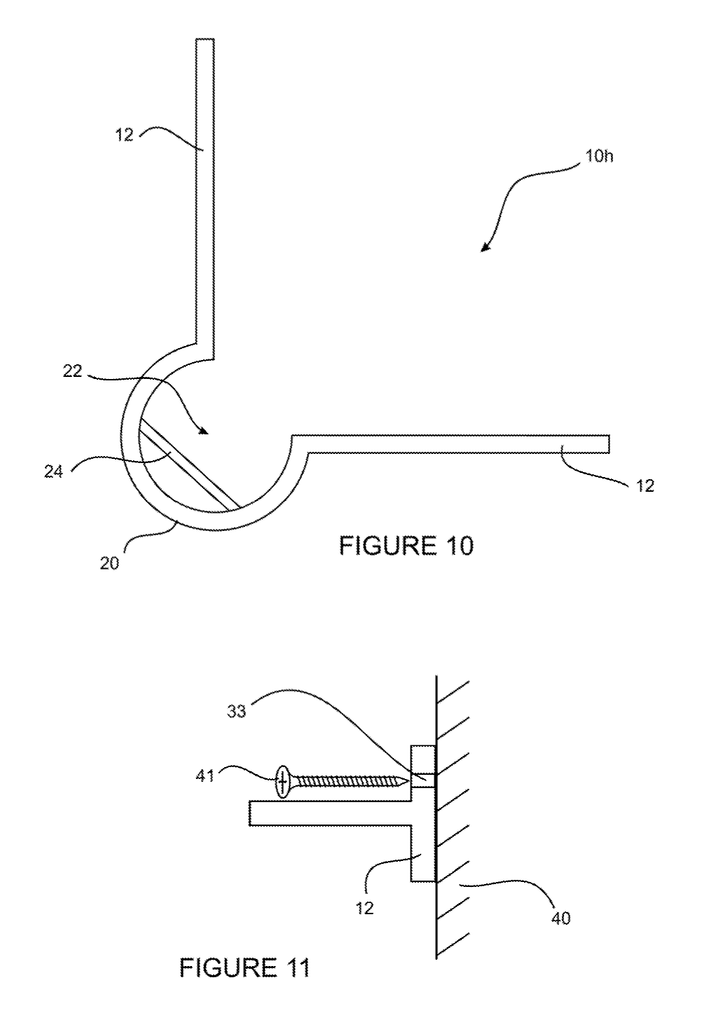

FIG. 10 shows another alternative embodiment of the square tool 10h which is similar to the embodiment 103 but further including a straight reinforcement member 24 between inner surfaces of the three-quarter ring connector 20.

As shown in FIG. 11, the arms 12 can have apertures 33 therein for attachment of the square tool 10 to the component 40 via a fastener 41.

The present invention thus allows a user to measure a 90 degree angle between two components where the corner between the components is obstructed by an object. The square tool has two straight arms (set at 90 degree) that are connected by one or more supporting connectors. These arms can be made of flat material or angled ‘L’ or ‘T’ section to allow for clamping or fastening to material (eg. to a fence rail). The connection support can be round, square, rectangle or angled in shape. This allows the user to measure off against the device to make necessary adjustments to items like downpipes, posts, cornices and other objects found in construction and project applications.

The square tool can be held, clamped or temporarily fastened to one component and used to line up another component at 90 degrees.

The present tool allows a user to measure a 90 degree (square) angle when there is something in the corner itself. Unlike traditional framing squares which are designed to make measurements for framing applications, the present invention can work around obstructions making it a very useful tool for the home handy man or tradesperson. The device can simply be held, clamped or temporarily fixed to material in order to affix other material squarely (at 90 degrees). This is particularly useful if working independently.

It can also be useful by trades people who need to screw, weld or otherwise connect two objects together within close proximity or on the corner itself as the tool allows for the drilling of fasteners or material close to the corner will little obstruction. An example of its use is during the installation of a shower screen where the corner is often obstructed by aluminium channel. The installer can easily check the screen for square by placing the tool directly on (or clamping to) both screens and then fasten the corner and wall brackets.

For fencing and concreting contractors, the present tool allows for 90 degree measuring around fence posts and forming pegs. Simply clamp to one axis, and set a string line up against the other axis to line up posts squarely at 90 degrees.

Whilst preferred embodiments of the present invention have been described, it will be apparent to skilled persons that modifications can be made to the embodiments described.

The present invention can also be adapted to provide tools to measure other angles between structure sections, such as 45°, 30° or 60° angles, for angled walls for example. The angle between the tool edges can be adjustable, for example by adapting the connector to provide adjustability. The connector for example can comprise two arc sections which are slidable relative to each other and lockable in relative position to vary the angle between the work edges.

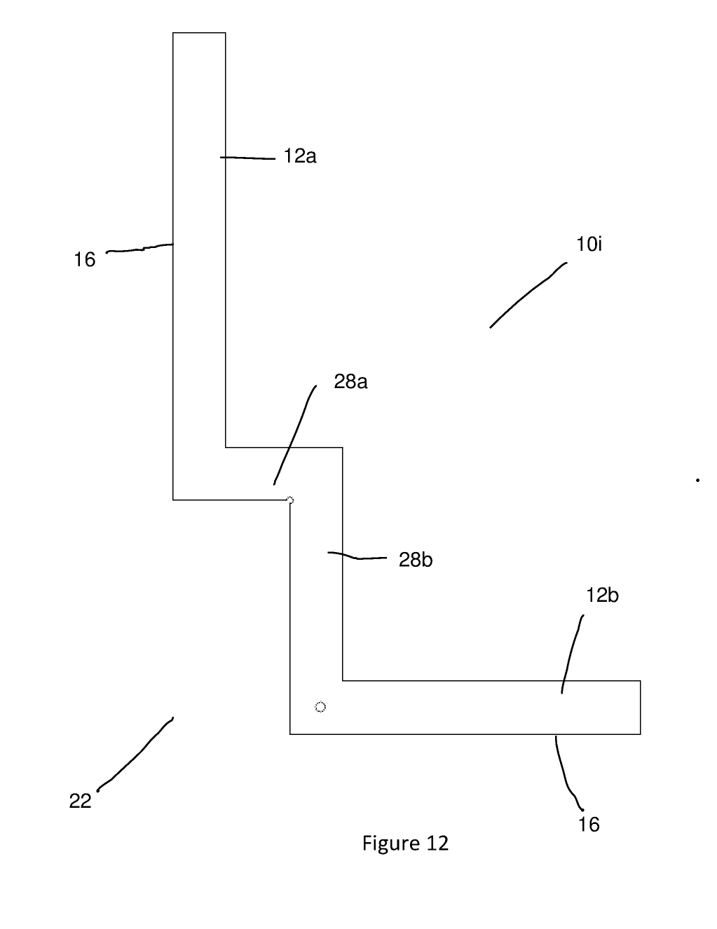

FIG. 12 shows another alternative embodiment of the square tool 10i which is similar to the embodiment 10g but where first section 28a is shorter than the second section 28b. In addition to providing a cornerless square capability, the 4 in 1 square tool version 10i contains three 90 degree angles in the one tool that can be used for measuring, adding a significant feature. This means users can measure 90 degrees from any axis in multiple places. The tool effectively has multiple square tools within itself.

1. A square tool comprising a first arm and a second arm having work edges disposed at 90° to each other, wherein the arms comprise inner ends spaced from each other and are joined by a connector therebetween, the connector providing a space for a projected corner junction of the first and second arms.

2. The square tool of claim 1 wherein the arms each have an outer edge which are set at right angles to each other.

3. The square tool of claim 1 wherein the connector extends directly between the inner ends, the connector being at an obtuse angle relative to the arms.

4. The square tool of claim 1 wherein the arms form a cross-section selected from a group consisting of a T-shaped cross-section, L-shaped cross-section and flat cross-section.

5. The square tool of claim 1 wherein the connector is a right angled connector directed away from the space.

6. The square tool of claim 1 wherein the connector extends from inner edges of the arms.

7. The square tool of claim 1 wherein the connector comprises first and second sections at a right angle to each other, where an end of each section is connected to a respective inner end of the arms.

8. The square tool of claim 1 wherein the connector is a curved connector in the shape of an arc.

9. The square tool of claim 1 wherein the connector extends from the outer edges of the arms.

10. The square tool of claim 1 wherein the connector is shaped as a three-quarter section of a ring.

11. A tool comprising:
a first arm; and
a second arm having work edges disposed at an angle to each other, wherein the arms comprise inner ends which are spaced from each other and are joined by a connector therebetween, the connector being provided with a space for a projected corner junction of the first and second arms.

12. The tool of claim 11 wherein the angle is a set angle selected from a group consisting of 45°, 60° and 30°.

13. The tool of claim 11 wherein the angle is adjustable, the connector being adapted to vary variable and setting the angle between the work edges.
